(19) United States
(12) Patent Application Publication
(10) Pub. No.: US 2002/0089195 A1
(43) Pub. Date: Jul. 11, 2002

(54) Striker of vehicle door latch device and manufacturing method thereof

(75) Inventors: Yukio Sawajiri, Yamanashi-ken (JP); Hiroyuki Sakagami, Yamanashi-ken (JP); Miki Ogino, Yamanashi-ken (JP)

Correspondence Address: BROWDY AND NEIMARK, P.L.L.C., 624 NINTH STREET, NW, SUITE 300, WASHINGTON, DC, 20001-5303, US

(73) Assignee: Mitsui Kinzoku Kogyo Kabushiki Kaisha, Tokyo (JP)

(21) Appl. No.: 10/032,326

(22) Filed: Dec. 31, 2001

(30) Foreign Application Priority Data
Dec. 30, 2000 (JP) 2000-404955

(51) Int. Cl. E05B 15/02

(52) U.S. Cl. 292/341; 292/340

(57) ABSTRACT

A striker of a vehicle door latch device comprises a longitudinal plate-like metal base and a U-shaped metal engaging member including a first leg part, a second leg part and a front connecting part. The first leg part has, at a front side portion thereof, a latch engaging part which is engageable with an engaging recess of a latch of the vehicle door latch device. The first leg part has, at a rear side portion thereof, a reinforced large diameter part with a larger diameter than that of the latch engaging part. A length of the reinforced large diameter part being 20% or more of the length of the first leg part.

### FIELD OF THE INVENTION

The present invention relates to a striker of a vehicle door latch device and a manufacturing method thereof.

### DESCRIPTION OF THE RELATED ART

The conventional and typical striker which is engaged with a latch of a door latch device to keep a vehicle door in the closed state, comprises, a metal base, and a U-shaped metal rod fixed to the base by caulking work or the like. The diameter of the metal rod is generally about 7 mm. A rod thinner than that of 7 mm brings insufficiency in strength of the striker, and a rod thicker than that of 7 mm makes the latch which has an engaging recess to be engaged with the rod large-sized. The large sized latch requires a large and heavy housing of the door latch device.

In U.S. Pat. No. 5,050,917, a striker having a U-shaped reinforced metal rod is described. The reinforced rod comprises an engaging leg part with a normal diameter which is engageable with the latch, a support leg part with a large diameter which is disengageable with the latch, and a large diameter connecting part which connects the respective outsides of the engaging leg part and the support leg part. The reinforced metal rod has succeeded in improvement of the strength of the striker without making the latch large-sized.

However, in the case of the above described reinforced rod, the manufacturing cost is high. In the case of the normal type striker made of a linear rod which has the same diameter from beginning to end, it can easily be formed in such a way where a linear rod is bent and shaped like a “U”, and after that, one pair of ends are fixed to the base by caulking work or the like, and therefore, the manufacturing cost is low. But in the case of the reinforced type striker, it is difficult to form that by a linear rod which has the same diameter from beginning to end, and the number of manufacturing processes is increased, and the cost rising is inevitable.

### SUMMARY OF THE INVENTION

Accordingly, it is an object of the present invention to provide a striker which has a reinforced type rod, and which can easily be manufactured.

### BRIEF DESCRIPTION OF THE DRAWINGS

FIG. 1 is a front view of a striker according to the present invention;

FIG. 2 is the A-A cross sectional view of FIG. 1;

FIG. 3 is the B-B cross sectional view of FIG. 1;

FIG. 4 is a schematic drawing showing the relation between the striker and a latch;

FIG. 5 is a plan view of a metal linear rod;

FIG. 6 is a plan view of a U-shaped rod; and

FIG. 7 is a cross sectional view showing the U-shaped rod and a press lower die.

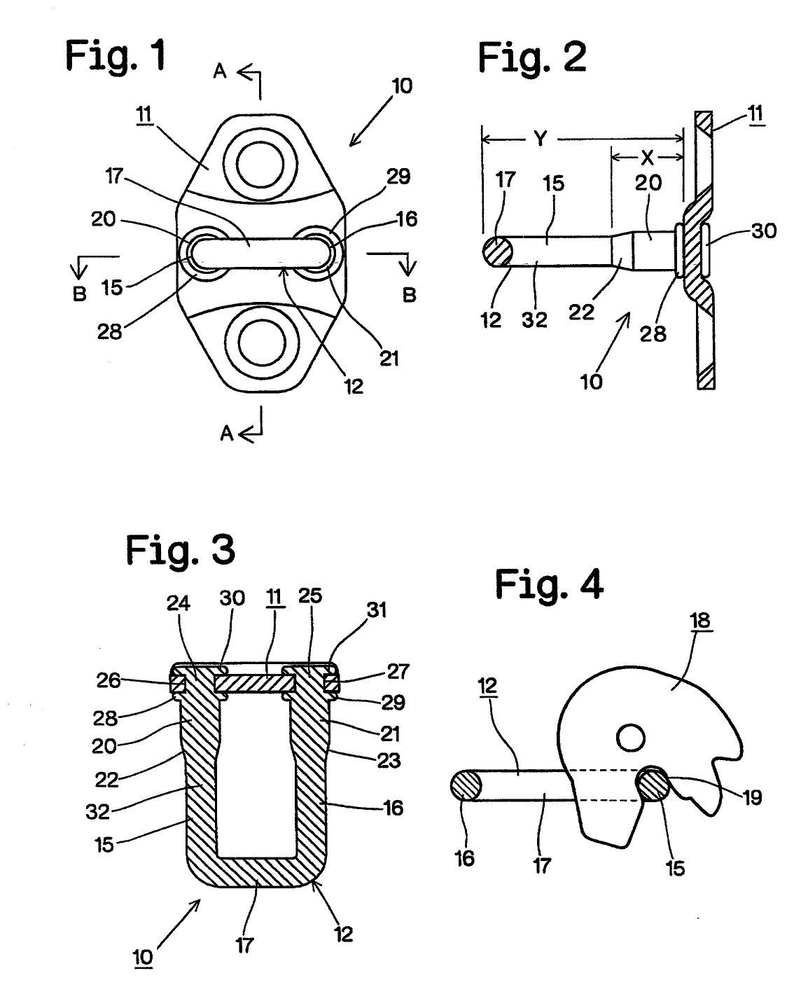

### DESCRIPTION OF THE PREFERRED EMBODIMENTS

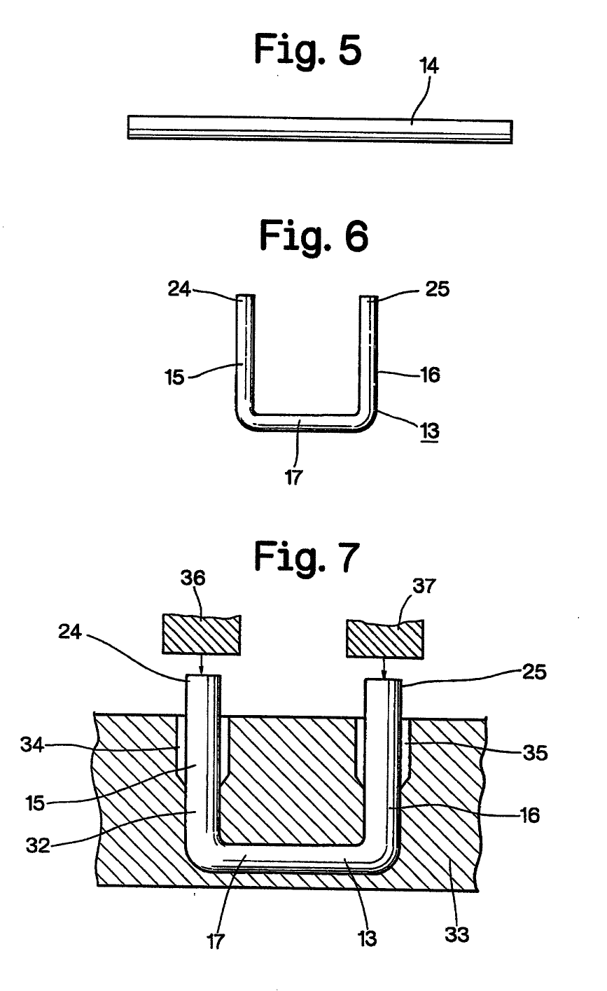

A striker 10 according to the present invention has a longitudinal plate-like metal base 11 which is fixed to a vehicle body (not shown in the figure) by a bolt or the like, and an approximately U-shaped engaging member 12 which is fixed to the base 11. A linear metal rod 14 (FIG. 5) which is used as the material of the engaging member 12 preferably has a round cross section with the same diameter at any portion, and first of all, it is cut to have a predetermined length. The cut linear rod 14 is bent by press work or the like, and is formed to be a U-shaped rod 13 which is composed of a first leg part 15 as an engaging side, a second leg part 16 as a support side, and a front connecting part disposed between the front end of the first leg part 15 and the front end of the second leg part 16. The first leg part 15 is, as shown in FIG. 4, engageable with an engaging recess 19 of a latch 18 of a vehicle door latch device to be attached to a vehicle door.

The first leg part 15 as a final product has a first reinforced large diameter part 20 at the rear side portion thereof, and similarly, the second leg part 16 has a second reinforced large diameter part 21. As shown in FIG. 7, the reinforced large diameter parts 20 and 21 are formed by press work. The U-shaped rod 13 is set in a press lower die 33 in the state where rear ends 24 and 25 of the leg parts 15 and 16 project upward from the press lower die 33. The press lower die 33 has large cavities 34 and 35 corresponding to the reinforced large diameter parts 20 and 21. When pressing the rear ends 24 and 25 which project from the press lower die 33 are pressed by press bars 36 and 37, the rear side portions of the leg parts 15 and 16 are swelled in the radial direction to form the reinforced large diameter parts 20 and 21. The reinforced large diameter parts 20 and 21 preferably have front tapered parts 22 and 23.

The rear ends 24 and 25 of the leg parts 15 and 16 are inserted into mounting holes 26 and 27 formed in the base 11, and after that, they are fixed to the base 11 by the front caulking flanges 28 and 29 and the rear caulking flanges 30 and 31. The front caulking flanges 28 and 29 are preferably formed before inserting the rear ends 24 and 25 into the mounting holes 26 and 27.

The first leg part 15 has a latch engaging part 32 engageable with the engaging recess 19 of the latch 18. The latch engaging part 32 is positioned on the front side of the first reinforced large diameter part 20 (tapered part 22), and the diameter of the latch engaging part 32 is the same as the diameter of the linear rod 14.

It is desirable that the length X of the first reinforced large diameter part 20 including the tapered part 22 and front flange 28 is 20% or more of the length Y of the first leg part 15.

Advantageous Effect of the Invention

The U-shaped rod 13 of the present invention can be formed by bending a linear metal rod 14 which has the same diameter from beginning to end, and therefore, it can be manufactured easily and at a low cost.

The reinforced large diameter parts 20 and 21 can be formed easily and at a low cost by press work.

The combination of the reinforced large diameter part 20 and the latch engaging part 32 having the same diameter as the linear rod 14 improves the strength of the striker 10 without making the latch of the door latch device large-sized.

What is claimed is:

1. A striker of a vehicle door latch device, comprising:
a longitudinal plate-like metal base to be fixed to a vehicle body; and
a U-shaped metal engaging member including a first leg part, a second leg part which is in parallel with the first leg part, and a front connecting part which connects a front end of the first leg part and a front end of the second leg part;
each of said first leg part and said second leg part having, at rear end thereof which projects on a rear side of the base through a mounting hole of the base, a rear caulking flange with a larger diameter than that of the mounting hole to be engaged with a rear surface of the base;
said first leg part having, at a front side portion thereof, a latch engaging part which is engageable with an engaging recess of a latch of the vehicle door latch device;
said first leg part having, at a rear side portion thereof, a reinforced large diameter part with a larger diameter than that of the latch engaging part, said reinforced large diameter part being positioned on the front side of the base;
wherein a length of said reinforced large diameter part being 20% or more of the length of the first leg part.

2. The striker of a vehicle door latch device according to claim 1, wherein said second leg part has the same shape as said first leg part.

3. The striker of a vehicle door latch device according to claim 1, wherein said latch engaging part has the same diameter as said front connecting part.

4. The striker of a vehicle door latch device according to claim 1, wherein a tapered part is provided between said reinforced large diameter part and said latch engaging part.

5. The striker of a vehicle door latch device according to claim 1, wherein the length of said reinforced large diameter part is 25% or more of the length of said first leg part.

6. The striker of a vehicle door latch device according to claim 1, wherein said second leg part has the same shape as said first leg part, and said latch engaging part has the same diameter as said front connecting part, and a tapered part is provided between said reinforced large diameter part and said latch engaging part.

7. The striker of a vehicle door latch device according to claim 6, wherein the length of said reinforced large diameter part is 25% or more of the length of said first leg part.

8. The striker of a vehicle door latch device according to claim 1, wherein the length of said reinforced large diameter part is 30% or more of the length of said first leg part.

9. The striker of a vehicle door latch device according to claim 1, wherein said reinforced large diameter part has a length of twice or more the length of said rear caulking flange, in the longitudinal direction of said first leg part.

10. The striker of a vehicle door latch device according to claim 1 wherein said reinforced large diameter part has a length of triple or more the length of said rear caulking flange, in the longitudinal direction of said first leg part.

11. A manufacturing method of a striker of a vehicle door latch device, comprising the steps of:
bending a linear metal rod with the same diameter from beginning to end to form a U-shaped rod including a first leg part, a second leg part which is in parallel with said first leg part, and a front connecting part which connects a front end of said first leg part and a front end of said second leg part;
setting said U-shaped rod in a press lower die having a cavity whose diameter is larger than the diameter of said linear metal rod, in the state where rear ends of said first and second leg parts project outward from the press lower die;
pressing the rear ends of said first and second leg parts by press bars to form reinforced large diameter parts whose diameter is larger than the diameter of said linear metal rod, at the rear side portions of said first and second leg parts which are positioned in said cavity, without changing the diameter of front side portions of said first and second leg parts; and
inserting said rear ends of said first and second leg parts into mounting holes of a metal base, and after that, fixing said rear ends to said metal base by caulking work.
